(19) United States
(12) Patent Application Publication
(10) Pub. No.: US 2007/0025475 A1
(43) Pub. Date: Feb. 1, 2007

(54) Method and apparatus for data signal processing in wireless RFID systems

(75) Inventor: Yuri Okunev, Middle Island, NY (US)

Correspondence Address: STERNE, KESSLER, GOLDSTEIN & FOX PLLC, 1100 NEW YORK AVENUE, N.W., WASHINGTON, DC, 20005, US

(73) Assignee: Symbol Technologies, Inc., Holtsville, NY (US)

(21) Appl. No.: 11/190,844

(22) Filed: Jul. 28, 2005

(51) Int. Cl. H04L 27/06

(52) U.S. Cl. 375/343

(57) ABSTRACT

The present invention provides methods and apparatuses for demodulation and decoding of backscattered RFID tag signals, represented by their in-phase and quadrature components at the output of the demodulator in the receiver portion of a reader interrogator. Autocorrelation coefficients for the in-phase and quadrature components of the received signal are calculated. The in-phase and quadrature coefficients are combined. The sign of output data is determined. Embodiments of the present invention are applicable to Gen 2 RFID systems as well as any wireless telecommunications system with the corresponding data modulation and/or encoding technique.

### BACKGROUND OF THE INVENTION

1. Field of the Invention

The present invention relates to wireless telecommunications apparatus, systems and methods. More specifically, the invention relates to Radio Frequency Identification (RFID) readers that receive, demodulate and decode signals from RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

In a RFID system, an interrogator first transmits a continuous wave (CW) or modulated radio frequency (RF) signal to a tag. The tag receives the signal, and responds by modulating the signal according to the reflection coefficient of the tag's antenna, thereby backscattering an information signal to the interrogator. Once an interrogator receives signals back from the tag, the interrogator demodulates, decodes and passes that information in digital form to a host computer, which further processes the information.

Development of reliable demodulation and decoding procedures for encoded backscattered signals is an important problem of all wireless system design, including wireless RFID systems. A RFID communication channel is usually plagued with severe interference, multipath propagation and fast fading, especially when a tag or/and a reader are moving. Additionally, the tag backscatter signal has considerable variation in its parameters. As a result, a tag backscatter signal has random delay, amplitude, frequency and phase, which are rapidly changing functions of time.

A recent RFID standard specifies communication parameters for a 2^{nd} generation of RFID systems, known as “Gen2 RFID systems” with extended data transmission capabilities, including different modulation and encoding techniques, and a wide spectrum of bit rates.

Thus, more efficient signal processing procedures are needed, which provide the highest possible performance at the simplest implementation of a base-band receiver portion of the reader interrogator.

### BRIEF SUMMARY OF THE INVENTION

Methods, systems, and apparatuses for operation and implementation of RFID reader interrogators capable of demodulating and decoding encoded backscattered signals from RFID tags are described.

A method of data decoding in a receiver is described, including an autocorrelation algorithm which provides convolution of two parts of each tag symbol interval, where there is a phase inversion in the middle of the data symbol, or there is no phase inversion. In an example aspect, the receiver calculates autocorrelation coefficients for in-phase and quadrature components (denoted as I and Q respectively) of a signal received from a tag, combines the in-phase and quadrature components, and determines the sign of the resulting output data.

In an aspect of the present invention, the autocorrelation algorithm is carried out by the base-band receiver part of a reader interrogator. In an example aspect, the base-band receiver portion includes two delay modules, two multipliers, an integrator, and a decision module.

A further aspect of the invention includes a digital version of the base-band receiver, operating with digital samples of I and Q signal components. In an example aspect, the digital version of the receiver includes two sample delay modules, two digital multipliers, an adder-accumulator, and a decision module.

Aspects of the present invention include a decoding algorithm applicable to all 2^{nd} Generation RFID modulation and encoding schemes including amplitude shift keying (ASK) and phase shift keying (PSK) modulation, and FM0 and Miller encoding techniques. Furthermore, the algorithms are adaptable to further modulation and encoding schemes.

These and other aspects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with each other as well as with an exemplary population of RFID tags, according to an embodiment of the present invention.

FIG. 2A shown a block diagram of the receiver portion of a RFID reader interrogator, according to an example of the present invention.

FIG. 2B shown a block diagram of a conventional receiver portion of a RFID reader interrogator.

FIGS. 3A and 3B show various sequences of a FM0 encoded signal that is transmitted from a RFID tag to a RFID reader interrogator.

FIGS. 4A, 4B, and 4C show various subcarrier sequences of a Miller encoded signal that is transmitted from a RFID tag to a RFID reader interrogator.

FIG. 5 shows a flowchart providing an example embodiment of the decoding algorithm of the present invention

FIG. 6 shows an example base-band receiver portion of a RFID reader interrogator for decoding binary signals, according to an embodiment of the present invention.

FIGS. 7 and 8 show example base-band receiver portions of RFID reader interrogators, configured for continuous and digital signal processing respectively, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to wireless telecommunications apparatus, systems and methods which implement data transmission via radio channels with variable parameters. More specifically, the invention relates to Radio Frequency Identification (RFID) reader interrogators, providing detection, demodulation and decoding of signals from tags.

Interaction between tags and reader interrogators takes place according to one or more RFID communication protocols, such as those approved by the RFID standards organization EPCglobal (EPC stands for Electronic Product Code). One example of a communication protocol is the widely accepted emerging EPC protocol, known as Generation-2 Ultra High Frequency RFID (“Gen 2” in short). Gen 2 allows a number of different tag “states” to be commanded by reader interrogators. A detailed description of the EPC Gen 2 protocol may be found in “EPC™ Radio-Frequency Identity Protocols Class-1 Generation-2 UHF RFID Protocol for Communications at 860 MHz-960 MHz,” Version 1.0.9, and published 2004, which is incorporated by reference herein in its entirety.

Once a reader interrogator receives a modulated response signal back from a RFID tag, the reader performs considerable amount of data processing to demodulate and decode the received signal.

Some conventional approaches to data processing use a “demapping algorithm”. A demapping algorithm is based on a correlation method. The correlation method involves computation of the correlation coefficients between a received signal and one or more a priori known reference signals. The reference signals comprise coherent or non-coherent replicas of the variants of the received signal. In correlation method-based decoding, a final decision on a data value received from a tag is made in favor of the reference signal which generates the greatest correlation coefficient with the received encoded signal.

There are at least two disadvantages to the correlation method used in existing RFID systems. A first disadvantage is related to an uncertainty in the accuracy of the reference signals in the receiver portion, caused by unpredictable and considerable variation in the subcarrier frequency. Such variation may result from a cycle period offset present in the tag transmitter. According to the Gen 2 specification, this variation can be equal to 15% of the cycle period. For example, if a nominal number of samples in a cycle period is equal to 64, the actual number of samples during the cycle period can range from 54 to 74. With this condition, the correlation method is decreased in accuracy (compared to the perfect reference), particularly in a multipath, noisy RF environment. Estimation of the frequency offset during preamble processing can decrease reference signal uncertainty. However, even the remaining frequency offset (variable within the data session) causes considerable energy to be lost.

A second disadvantage of the correlation method is its realization complexity. The correlation method involves multiplication of received signal and reference samples, saving reference samples, and adaptive adjustment of reference parameters. All these operations require very high speed digital signal processing (DSP) in advanced RFID systems with the highest data rate.

Thus, data processing in RFID systems needs new methods and apparatus for realization, combining high enough performance and very simple device implementation.

The present invention provides methods and apparatuses for demodulation and decoding of backscattered tag signals, represented by their in-phase and quadrature components in the receiver portion of a reader interrogator. It is noted that the receiver portion of the reader interrogator is often referred to as “reader receiver” in the present application. Additionally, please note that the in-phase and quadrature components of a received encoded signal are in quadrature phase (i.e., 90°) with respect to each other.

Thus, both are referred as quadrature components of the received signal. For sake of differentiation and clarity, we have labeled and described one of the components as an in-phase component (I), and the other component as a quadrature component (Q).

The methods and systems described in the present application have several advantages compared to the conventional correlation method. The method provides stable performance and reliable decision making even with considerable variation of backscattered signal parameters. Reference signals are not used. Embodiments of the present invention provide both reliable data decoding and simple device implementation of the base-band portion of reader receivers.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Example RFID System Embodiment

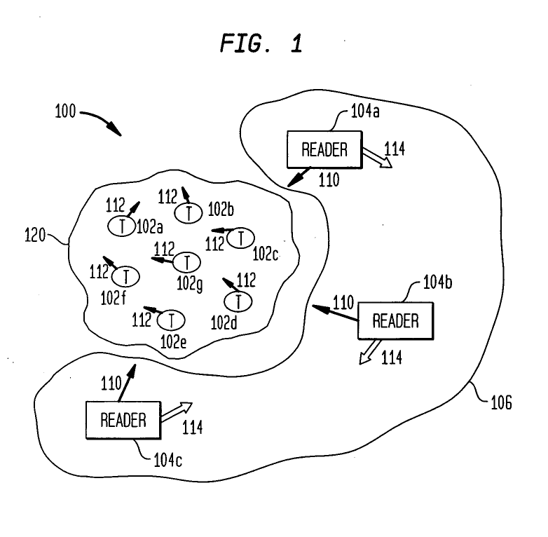

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102.

Environment 100 includes either a single reader 104 or a plurality of readers 104, such as readers 104a-104c. In an embodiment, a reader 104 may be requested by an external application to address the population of tags 120. Alternatively, reader 104 may have internal logic that initiates communication, or may have a trigger mechanism that an operator of reader 104a uses to initiate communication.

As shown in FIG. 1, readers 104 transmit an interrogation signal 110 having a carrier frequency to the population of tags 120. Readers 104 operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102.

In addition to being capable of communicating with tags 102, readers 104a-104c may communicate among themselves in a reader network 106. Each of readers 104a-104c transmits reader signals 114 to others of readers 104a-104c, and receives reader signals 114 from others of readers 104a-104c.

The present invention works in an environment (with reference to FIG. 1) where reader-to-tag, tag-to-reader, and reader-to-reader communication is allowed. Specifically, the present invention refers to the tag-to-reader communication, and the subsequent signal processing performed in the receiver portion of the reader.

Example Conventional RFID Reader Embodiment

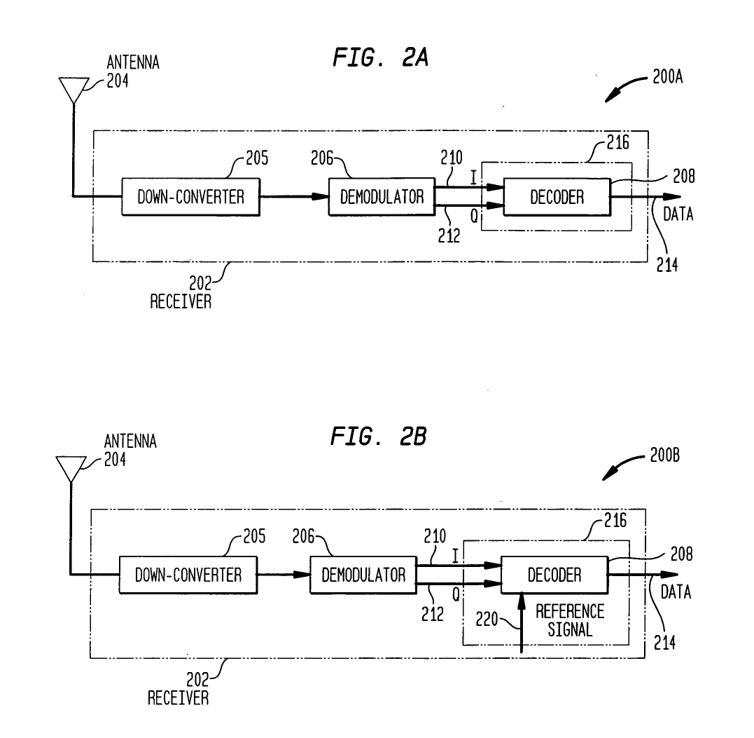

FIG. 2A shows an example block diagram of the receiver portion of a conventional RFID reader 200A. Reader 200A typically includes one or more antennas 204, one or more receivers 202, one or more transmitters, one or more memory units, and one or more processors (transmitters, memory units, and processors are not shown in FIG. 2A). As shown in the example of FIG. 2A, receiver 202 includes a frequency down-converter 205, a demodulator 206, and a decoder 208. These components of reader 200A may include software, hardware, and/or firmware, or any combination thereof, for performing their functions, which are described in further detail in subsequent sections herein.

Reader 200A has at least one antenna 204 for communicating with tags 102 and/or other readers 104. In an example FCC environment, interrogator transmission and tag responses are spectrally separated. Typically, an interrogator sends an interrogation signal at higher frequency, and tags respond at a lower frequency. A tag response signal includes data modulated according to an amplitude shift keying (ASK), phase shift keying (PSK), or other modulation format.

Down-converter 205 receives the tag response signal through antenna 204 and down-converts the response signal to a frequency range amenable to further signal processing.

Demodulator 206 is coupled to an output of down-converter 205, and receives the modulated and frequency down-converted tag response signal from down-converter 205. Demodulator 206 is demodulates the down-converted tag response signal. At the output of demodulator 206, the tag response signal is represented by an in-phase component 210 (denoted as I), and a quadrature-phase component 212 (denoted as Q).

Decoder 208 is coupled to an output of demodulator 206 and receives in-phase and quadrature components 210 and 212, respectively. Gen 2 tag response signals encode backscattered data as either FM0 baseband or Miller modulation of a subcarrier at the data rate. The reader interrogator commands the encoding choice. Different sub-components included within decoder 208 are further described below with reference to subsequent figures. Decoder 208 executes one or more algorithms in order to generate decoded data signal 214.

Signal components 210 and 212 along with decoder 208 comprise the base-band portion 216 of receiver 202. Embodiments for base-band portion 216 are described in further detail below.

FIG. 2B shows another reader interrogator 200B similar to reader interrogator 200A (shown in FIG. 2A) with one or more additional input reference signals 220 in base-band portion 216 of the reader receiver. Signal 220 is an a priori known reference signal. As mentioned before, conventional reader receivers generate and save reference signal(s) 220, adaptively adjust reference signal parameters, and multiply backscattered tag signal and reference signal(s) in order to calculate correlation coefficients. These steps necessitate complicated decoder device capable of high speed digital signal processing (DSP). Thus, reader interrogator 200B is a less efficient configuration than reader interrogator 200A of FIG. 2A. As will be discussed later, embodiments of the present invention do not require reference signal(s) 220, making the device implementation and signal processing operation much simpler.

Example RFID Data Encoding Techniques

FM0 baseband and Miller modulation of a subcarrier are the two most commonly used data encoding techniques used in backscattered signals received by an RFID reader interrogator from a RFID tag.

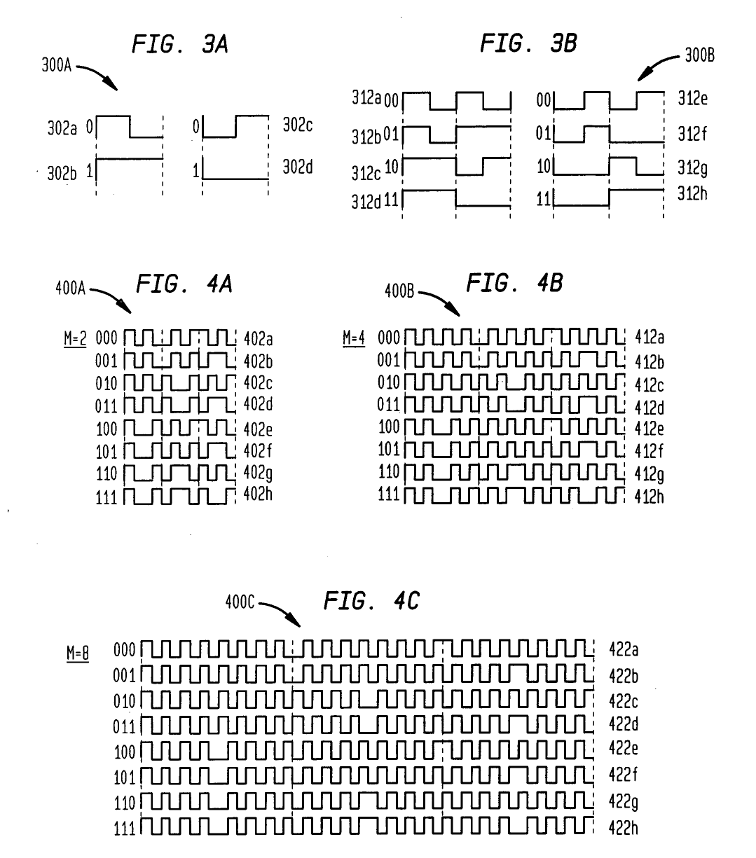

FIGS. 3A and 3B illustrate characteristics of FM0 encoded data. FM0 encoding is also known as bi-phase space encoding. FM0 inverts the baseband phase at every symbol boundary. Additionally, a data symbol representing ‘0’, also known as data-0, undergoes a mid-symbol phase inversion. A data symbol representing ‘1’, also known as data-1, does not undergo this additional mid-symbol phase inversion. Data-0 symbols 302a and 302c are two possible representations of a data ‘0’ in FM0 encoded symbols. Data-1 symbols 302b and 302d are two possible representations of a data ‘1’ in FM0 encoded symbols.

FIG. 3B shows example FM0 sequences generated by arranging FM0 symbols depicted in FIG. 3A. Sequences 312a and 312e are “00” data sequences, sequences 312b and 312f are “01” data sequences, sequences 312c and 312g are “10” data sequences, and sequences 312d and 312h are “11” data sequences. For example, sequence 312c is generated by concatenating a data-1 symbol 302b and a data-0 symbol 302c. As shown in FIG. 3B, there is a phase inversion in each sequence at the boundary between symbols, as indicated at the center vertical dotted line through each of sequences 312a-312h.

FIGS. 4A, 4B, and 4C illustrate characteristics of Miller encoded data. A baseband Miller encoder inverts phase between two data-0s in sequence. The baseband Miller encoder also places a phase inversion in the middle of a data-1 symbol. FIGS. 4A-4C show Miller-modulated subcarrier sequences. FIG. 4A shows sequences 402a-402h. FIG. 4B shows sequences 412a-412h. FIG. 4C shows sequences 422a-422h. A Miller sequence contains exactly two, four, or eight subcarrier cycles per bit, depending on the ‘M’ value specified in the command initiated by the reader interrogator. FIG. 4A shows Miller subcarrier sequences corresponding to M=2, FIG. 4B shows Miller subcarrier sequences corresponding to M=4, and FIG. 4C shows Miller subcarrier sequences corresponding to M=8.

Example Embodiment of RFID Data Decoding Method

Embodiments of the present invention is applicable to Gen 2 RFID modulation and encoding modes including ASK and PSK modulation, and FM0 and Miller encoding, and is adaptable to further RFID protocol, modulation schemes, and encoding methods, as would be understood by persons skilled in the relevant art(s) by the teachings herein. In embodiments, a fundamental property of the received signal is utilized, that for any modulation technique, both FM0 and Miller base-band signals have a phase inversion in the middle of the data symbol: in the middle of data-0 symbol (FM0) or in the middle of data-1 symbol (Miller).

It is assumed that a RFID receiver provides conventional linear transformation of the received high-frequency signal to the base-band components I and Q of the modulated carrier, such as according to the example configuration of receiver 202 shown in FIG. 2A. As mentioned previously, I and Q are in quadrature with respect to each other. We describe the in-phase component as I, and quadrature-phase component as Q. Additionally, it is assumed that signal components I and Q, presented by their samples, do not contain a constant (DC) component in them.

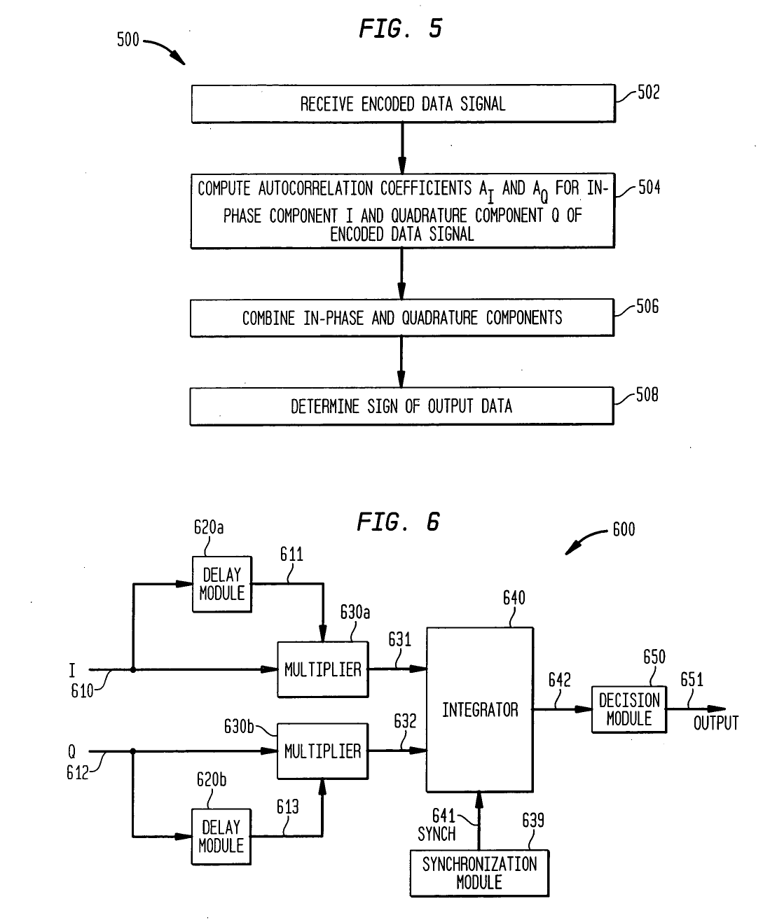

FIG. 5 shows a flowchart 500 providing example steps for an autocorrelation method of the present invention. The steps of flowchart 500 can be performed by embodiments of readers described herein. Other structural and operational embodiments will be apparent to persons skilled in the relevant art(s) based on the following discussion related to flowchart 500. The steps shown in FIG. 5 do not necessarily have to occur in the order shown.

Flowchart 500 begins with step 502. In step 502, a receiver receives encoded data signal from a source. For example, if the receiver is included in a RFID reader interrogator, then it can receive backscattered data from a RFID tag in response to the interrogation command issued by the interrogator. For instance, the receiver can be receiver 202 shown in FIG. 2A. Received data is encoded, and is present in in-phase component I and quadrature-phase component Q, such as in-phase and quadrature components 210 and 212 shown in FIG. 2A.

In step 504, the receiver computes autocorrelation coefficients Al for the in-phase signal component, and AQ for the quadrature component. Example algorithms involved in the autocorrelation coefficient calculation will be discussed later with reference to further embodiments below.

In step 506, the receiver combines the in-phase and quadrature components to generate a combined signal.

In step 508, the receiver determines the sign of the output data based on the encoding technique used in the received signal.

In an embodiment, base-band portion 216 of FIG. 2A performs the calculations/operations of steps 504, 506, 508. Detailed embodiments for base-band portion 216, and further detail regarding the steps of flowchart 500 are described in further detail below.

Example Apparatus Embodiments

FIG. 6 shows the base-band portion 600 of a receiver used in wireless communication system, configured to execute the steps of the autocorrelation algorithm described by flowchart 500. As shown in FIG. 6, base-band portion 600 includes first and second delay modules 620a and 620b, first and second multipliers 630a and 630b, an integrator 640, a synchronization module 639, and a decision module 650.

As shown in FIG. 6, first delay module 620 a receives an in-phase signal component 610 and outputs a delayed in-phase signal component 611. Second delay module 620b receives a quadrature signal component 612 and outputs a delayed quadrature signal component 613. First and second delay modules 620a and 620b respectively delay their input signals by a known amount. For example, first and second delay modules 620a and 620b may delay their respective input signals by an amount based on a length of a tag data symbol (i.e., a “tag symbol interval”) having a length T, such as a delay of T, T/2, or other amount.

First multiplier 630a receives in-phase signal component 610 and delayed in-phase signal component 611. Second multiplier 630b receives quadrature signal component 612 and delayed quadrature signal component 613. First multiplier 630a multiplies in-phase signal component 610 and delayed in-phase signal component 611 to generate multiplied in-phase signal 631. Second multiplier 630b multiplies quadrature signal component 612 and delayed quadrature signal component 613 to generate multiplied quadrature signal 632.

Integrator 640 receives a synchronization signal 641, multiplied in-phase signal 631, and multiplied quadrature signal 632. Integrator 640 integrates both of multiplied in-phase signal 631 and multiplied quadrature signal 632 according to synchronization signal, 641, and combines the integration results to generate an integrated combined signal 642. Alternatively, the combination of the integration results may occur outside of integrator 640. Synchronization signal 641 is generated by a synchronization module 639.

Note that in an embodiment, delay modules 620a and 620b, multipliers 630a and 630b, and integrator 640 perform step 504 of flowchart 500 shown in FIG. 5. Furthermore, integrator 640 (or a signal combiner outside of integrator 640 ) perform step 506 of flowchart 500.

Decision module 650 receives integrated combined signal 642, and outputs an output data signal 641. In an embodiment, decision module 650 assigns a data value and/or a sign value to a data symbol received in integrated combined signal 642.

Note that in an embodiment, decision module 650 performs step 508 of flowchart 500 shown in FIG. 5.

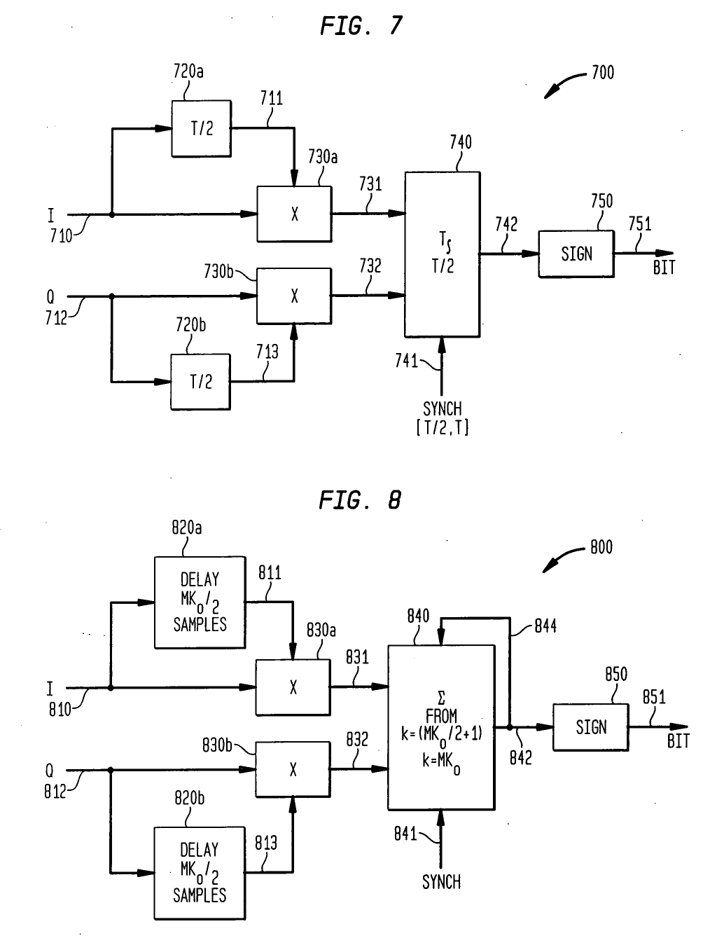

FIGS. 7 and 8 show example detailed base-band receiver portion embodiments for base-band portion 600. FIG. 7 shows a block diagram of a base-band receiver 700 capable of processing a temporally continuous signal, such as an analog signal. Base-band receiver 700 of FIG. 7 comprises fumctional modules and signals generally similar to the corresponding modules and signals described in FIG. 6. The corresponding components in FIGS. 6 and 7 bear similar numbering, with the sole exception of the left-most digit of each reference numeral, which indicates the corresponding Figure number.

The general scheme of operation of base-band receiver 700 is now described with reference to the example functional modules and signals shown in FIG. 7.

An in-phase signal component I(t) 710 and a quadrature signal component Q(t) 712 are received separately by base-band receiver 700 at the output of the demodulator 206 shown in FIG. 2A. In-phase signal component I(t) 710 and quadrature signal component Q(t) 712 include continuous, non-discrete waveform signals.

A first delay module 720 a receives in-phase signal component I(t) 710, and delays I(t) 710 by T/2, where a data symbol has a length of T over a time interval of t=0 to t=T. Similarly, a second delay module 720b receives quadrature-phase signal component Q(t) 712, and delays Q(t) 712 by T/2.

A first multiplier 730 a multiplies in-phase signal component I(t) 710 and a delayed in-phase signal component 711 (e.g., I(t−T/2)) output by first delay module 720a, to generate a multiplied in-phase signal 731. For example, multiplied in-phase signal 731 may be the product I(t)I(t−T/2). In a similar manner, a second multiplier 730b multiplies quadrature-phase signal component Q(t) 712 and a delayed quadrature signal component 713 (e.g., Q(t−T/2)) output by second delay module 730b to generate a multiplied quadrature signal 731. For example, multiplied quadrature signal 731 may be the product Q(t)Q(t−T/2).

Note that first and second multipliers 730a and 730b may be any conventional multipliers, or other multipliers, for multiplying continuous signals, as would be known to persons skilled in the relevant art(s).

Multiplied in-phase and quadrature signals 731 and 732 are received by an integrator 740. Integrator 740 integrates signal 731 to generate an in-phase autocorrelation coefficient A_{I}, according to the equation,

$${A}_{I} = {\int }_{T / 2}^{T} I ( t ) I ( t - T / 2 ) ⅆ t \qquad ( Equation 1 )$$

where multiplied in-phase signal 731 is the product I(t)I(t−T/2).

Similarly, integrator 740 integrates signal 732 to generate a quadrature-phase autocorrelation coefficient A_{Q}, according to the equation,

$${A}_{Q} = {\int }_{T / 2}^{T} Q ( t ) Q ( t - T / 2 ) ⅆ t \qquad ( Equation 2 )$$

where multiplied quadrature signal 732 is the product Q(t)Q(t−T/2). Note that the same channel or separate channels in integrator 740 may be used to integrate multiplied in-phase and quadrature signals 731 and 732.

Note that integrator 740 may be any conventional integrator, or other integrator, for integrating continuous signals, as would be known to persons skilled in the relevant art(s). For example, integrator 740 may include one or more amplifiers with accumulating capacitors configured in an integrating configuration, etc.

It is noted that integrator 740 accumulates its input signals during a half of the symbol interval from T/2 to T according to equations 1 and 2. The interval of integration is provided by symbol synchronization signal 741. In an embodiment, receiver 700 includes a synchronization module (not shown in FIG. 7) that generates symbol synchronization signal 741.

Integrator 740 combines A_{I} and A_{Q} to generate a combined signal 742. In an embodiment, combined signal 742 is calculated according to:
A=A_{I}+A_{Q}, (Equation 3)
where A is combined signal 742. Combined signal 742 includes a decoded data symbol. Alternatively, the combination of A_{I} and A_{Q} may occur outside of integrator 740.

Decision module 750 receives combined signal 742 and determines a sign for the decoded data symbol at the end of symbol interval (t=T). This sign is uniquely related to the transmitted bit depending on the encoding technique. An output signal 751 of decision module 750 decides on a sign for the data symbol, according to:
Decision=sign(A) for FM0 encoding, and (Equation 4)
Decision=−sign(A) for Miller encoding, (Equation 5)
Thus, in other words, if the data received from the tag is FM0 encoded, the sign of combined signal 742 is not changed, and if the data received from the tag is Miller encoded, the sign of combined signal 742 is inverted. Furthermore, the data symbol equals a zero “0” data value if the determined sign is negative. If the determined sign is positive, the data value for the data symbol is a one “1” data value. In this manner, base-band receiver portion 700 is able to determine a data value for a symbol received from a tag.

FIG. 8 shows digital base-band receiver portion 800, according to an example embodiment of the present invention. Digital base-band receiver portion 800 is configured similarly to base-band portion 700 of FIG. 7. An in-phase signal component I (kΔt) 810 and a quadrature signal component Q(kΔt) 812 are received separately by base-band receiver portion 800 at the output of the demodulator 206 shown in FIG. 2A. In-phase signal component I(kΔt) 810 and quadrature signal component Q(kΔt) 812 include discrete waveform signals.

For example, signal components 810 and 812 may be the k-th samples of the in-phase and quadrature components of the received modulated carrier at the output demodulator 206 within the symbol interval. Digital base-band receiver portion 800 comprises functional modules and signals generally analogous to those of base-band receiver portion 700 of FIG. 7, as discussed in the previous section. Thus, for the sake of brevity, details of base-band receiver portion 800 analogous to those of base-band receiver portion 700 may not necessarily be described below.

For the FM0 and Miller encoding techniques utilized in the Gen2 RFID communication protocol, the following designations are used:
t=time;

K₀=a number of samples within a subcarrier cycle, which is equal to the FM0 bit interval;

T=duration of a data symbol of the received encoded data signal,

M=a number of cycles within T, where M is equal to 1 for the FM0 mode and 2, 4, or 8 for the Miller mode;

MK₀=an even number of samples within T;
Δt=T/MK₀; and
k=1,2, . . . ,MK₀.

As shown in FIG. 8, digital base-band receiver portion 800 includes first and second samples delay modules (e.g., memory units) 820a and 820b, first and second digital multipliers 830a and 830b, an adder-accumulator 840, a synchronization module (not shown in FIG. 8), and a decision module 850.

Similar to base-band receiver portion 700 in FIG. 7, in-phase and quadrature signal components 810 and 812 are separately fed to digital multipliers 830a and 830b and to the delay modules 820a and 820b. Delay modules 820a and 820b introduce MK₀/2-samples delay to the original signal components. Delayed signals 811 and 813 are multiplied with their corresponding non-delayed in-phase and quadrature signals 810 and 812 to generate multiplied in-phase and quadrature signals 831 and 832, respectively.

Multiplied in-phase and quadrature signals 831 and 832 are received by adder-accumulator 840. Adder-accumulator 840 performs summations of input samples during a half of the symbol interval from k=(MK₀/2+1) to k=MK₀. In-phase autocorrelation co-efficient A_{I,d} and quadrature-phase autocorrelation coefficient A_{Q,d}, for digital base-band receiver portion 800 are calculated according to the following equations,
A_{I,d}=ΣI(kΔt)*I[(k−MK₀/2)Δt] (Equation 6)
A_{Q,d}=ΣQ(kΔt)*Q[(k−MK₀/2)Δt] (Equation 7)
where summation is taken over samples within the second half of the bit interval from k=(MK₀/2+1) to k=MK₀. An interval of the summation is provided by symbol synchronization signal 841 (a synchronization unit generating signal 841 is not shown in FIG. 8).

In an embodiment, the in-phase and quadrature-phase autocorrelation coefficients A_{I,d} and A_{Q,d} may be combined according to the equation,
A_{d}=A_{I,d}+A_{Q,d} (Equation 8)

Decision module 850 determines a sign of the adder-accumulator output combined signal 842 (A_{d}) at the end of the symbol interval (at the moment corresponding to the last sample of the symbol) for a data symbol in combined signal 842. In a similar fashion as described above for decision module 750 of FIG. 7, in an embodiment, a decision is made by decision module 850 to determine the sign of combined signal 842, according to the following equations,
Decision=sign(A_{d}), for FM0 encoding, (Equation 9)
Decision=−sign(A_{d}), for Miller encoding, (Equation 10)
Thus, in other words, if the data received from the tag is FM0 encoded, the sign of combined signal 842 is not changed, and if the data received from the tag is Miller encoded, the sign of combined signal 842 is inverted. Furthermore, the data symbol equals a zero “0” data value if the determined sign is negative. If the determined sign is positive, the data value for the data symbol is a one “1” data value. In this manner, digital base-band receiver portion 800 is able to determine a data value for a symbol received from a tag.

It should be noted that digital base-band receiver 800 in FIG. 8 provides data decoding for both FM0 and Miller modes. The only difference in decoding the different modes is the duration of the samples delay and the accumulation interval in the adder-accumulator—both are equal to MK₀/2 samples, where M=1 for the FM0 mode and M=2, 4, or 8 for the Miller mode. For example, if the subcarrier cycle contains 8 samples (K₀=8), the delays and accumulation intervals are equal to 4 samples for FM0, and 8, 16 and 32 samples for Miller with index M=2, 4, and 8, correspondingly.

Stochastic simulation-based testing of the embodiment of FIG. 8 was carried out for an Additive-White-Gaussian-Noise (AWGN) channel. In the simulations, dispersion (average power) of each sample of I/Q noise component was set equal to 1, and the signal-to-noise ratio (SNR) was set by changing the amplitude of the carrier. The test included up to 15×10⁶ bits, and each bit contained 8, 16, 32, or 64 samples depending on the Miller index M (M=1, 2, 4, or 8). Each test was repeated for random phase difference between the carrier and the reference in the demodulator. It was found that the results were invariant to the phase difference.

The conventional correlation algorithm at ideal conditions was also simulated for comparison. According to the estimation, the energy loss of the autocorrelation algorithm compared to the ideal correlation algorithm ranged from 1.3 dB to 4.0 dB depending on index M. It should be noted that actual energy loss would be less because of noise bandwidth limitation. This loss is quite acceptable considering the advantages gained from simplification provided by the proposed method and apparatus.

Example advantages for various receiver embodiments are described below.

Stable performance is provided for both the FM0 and Miller modes, which does not depend on variations in carrier parameters.

Adaptive correction of signal parameters during the data session is not required, with exception of symbol synchronization.

A relatively simple implementation is provided for both FM0 and Miller modes. For example, in the embodiment of FIG. 8, only two multipliers and 1 adder accumulator was needed, instead of 4 multipliers and 4 adder-accumulators in an existing correlation receiver.

Embodiments of the present invention are independent of reference signals

In embodiments, the autocorrelation algorithm accumulates sample roducts during a half of the bit interval.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for decoding an encoded data signal, comprising:
(a) receiving the encoded data signal having an in-phase signal component I(t) and a quadrature-phase signal component Q(t);
(b) computing an autocorrelation coefficient A_{I} for the in-phase signal component I(t), wherein the autocorrelation coefficient A_{I} is determined by
$${A}_{I} = {\int }_{T / 2}^{T} I ( t ) I ( t - T / 2 ) ⅆ t ,$$
where
t=time, and
a data symbol of the encoded data signal begins at t=0 and ends at t=T;
(c) computing an autocorrelation coefficient AQ for the quadrature-phase signal component Q(t), wherein the autocorrelation coefficient A_{Q} is determined by
$${A}_{Q} = {\int }_{T / 2}^{T} Q ( t ) Q ( t - T / 2 ) ⅆ t ;$$
(d) combining autocorrelation coefficients A_{I} and A_{Q} to generate a combined signal A that includes a decoded data symbol,
where
A=A_{I}+A_{Q}; and
(e) determining a sign for the decoded data symbol.

2. The method of claim 1, wherein the encoded data signal comprises data from a backscattered signal received from a radio frequency identification (RFID) tag.

3. The method of claim 1, wherein the encoded data signal comprises FM0 encoded data, wherein step (e) comprises:
determining a binary data symbol to be corresponding to the sign of combined signal A, wherein the data symbol equals 0 if the sign is negative, and the data symbol equals 1 if the sign is positive.

4. The method of claim 1, wherein the encoded data signal comprises Miller encoded data, wherein step (e) comprises:
determining a binary data symbol to be corresponding to opposite to the sign of combined signal A, wherein the data symbol equals 1 if the determined sign is negative, and the data symbol equals 0 if the determined sign is positive.

5. A base-band receiver, comprising:
a first delay module that receives an in-phase signal component I(t) of an encoded data signal, and delays the in-phase signal component I(t) by T/2, where
t=time, and
a data symbol of the encoded signal begins at t=0 and ends at t=T;
a second delay module that receives a quadrature-phase signal component Q(t) of the encoded data signal, and delays the quadrature-phase signal component Q(t) by T/2;
a first multiplier that multiplies the in-phase signal component I(t) and the delayed in-phase signal component to generate I(t)I(t−T/2);
a second multiplier that multiplies the quadrature-phase signal component Q(t) and the delayed quadrature-phase signal component to generate Q(t)Q(t−T/2);
an integrator that integrates I(t)I(t−T/2) to generate an in-phase autocorrelation coefficient A_{I}, according to
$${A}_{I} = {\int }_{T / 2}^{T} I ( t ) I ( t - T / 2 ) ⅆ t ,$$
wherein the integrator integrates Q(t)Q(t−T/2) to generate a quadrature-phase autocorrelation coefficient AQ, according to
$${A}_{Q} = {\int }_{T / 2}^{T} Q ( t ) Q ( t - T / 2 ) ⅆ t ,$$
wherein the integrator combines A_{I} and A_{Q} to generate a combined signal A that includes a decoded data symbol, according to
A=A_{I}+A_{Q}; and
a decision module that determines a sign for the decoded data symbol.

6. The receiver of claim 5, wherein the receiver is included in a radio frequency identification (RFID) reader interrogator device.

7. The receiver of claim 5, wherein each of the first and second delay modules comprises a memory unit configured to delay the received signal component by T2.

8. The receiver of claim 5, wherein the integrator accumulates I(t)I(t−T/2) and Q(t)Q(t−T/2) during t=T/2 to t=T.

9. The receiver of claim 5, further comprising a synchronization module that generates a symbol synchronization signal, wherein the integrator receives the symbol synchronization signal.

10. The receiver of claim 5, wherein the received encoded data signal comprises FM0 encoded data, wherein the decision module determines a binary data symbol to be corresponding to the sign of combined signal A, wherein the data symbol equals 0 if the sign is negative, and the data symbol equals 1 if the sign is positive.

11. The receiver of claim 5, wherein the received encoded data signal comprises Miller encoded data, wherein the decision module determines a binary data symbol to be corresponding to opposite to the sign of combined signal A, wherein the data symbol equals 1 if the sign is negative, and the data symbol equals 0 if the sign is positive.

12. A method for digitally decoding an encoded data signal, comprising:
(a) receiving the encoded data signal having an in-phase signal component I(kΔt), and a quadrature-phase signal component Q(kΔt);
(b) computing an autocorrelation coefficient A_{I,d} for the in-phase signal component I(kΔt), wherein the autocorrelation coefficient A_{I,d} is determined by
A_{I,d}=ΣI(kΔt)*I[(k−MK₀/2)Δt]
where summation is performed over samples from k=(MK₀/2+1) to k=MK₀, where
t=time,
K₀=a number of samples within a subcarrier cycle,
T=duration of a data symbol of the encoded data signal,
M=a number of cycles within T,
MK₀=an even number of samples within T,
Δt=T/MK₀,
k=1,2, . . . , MK₀;
(c) computing an autocorrelation coefficient A_{Q,d} for the quadrature-phase signal component Q(kΔt), wherein the autocorrelation coefficient A_{Q,d} is determined by
A_{Q,d}=ΣQ(kΔt)*Q[(k−MK₀/2)Δt]
where summation is performed over samples from k=(MK₀/2+1) to k=MK₀;
(d) combining autocorrelation coefficients A_{I,d} and A_{Q,d} to generate a combined signal A_{d} that includes a decoded data symbol, where
A_{d}=A_{I,d}+A_{Q,d}; and
(e) determining a sign for the decoded data symbol.

13. The method of claim 12, wherein the encoded data signal comprises FM0 encoded data, wherein M is equal to 1, wherein step (e) comprises:
determining a binary data symbol to be corresponding to the sign of combined signal A_{d}, wherein the data symbol equals 0 if the sign is negative, and the data symbol equals 1 if the sign is positive.

14. The method of claim 12, wherein the encoded data signal comprises Miller encoded data, wherein M is equal to 2, 4, or 8, wherein step (e) comprises:
determining a binary data symbol to be corresponding to opposite to the sign of combined signal A_{d}, wherein the data symbol equals 1 if the sign is negative, and the data symbol equals 0 if the sign is positive.

15. A digital receiver, comprising:
a first delay module that receives an in-phase signal component I(kΔt) of an encoded data signal, and delays the in-phase signal component I(kΔt) by MK₀/2, where
t=time,
K₀=a number of samples within a subcarrier cycle,
T=duration of a data symbol of the encoded data signal,
M=a number of cycles within T,
MK₀=an even number of samples within T,
Δt=T/MK₀, and
k=1,2, . . . , MK₀;
a second delay module that receives a quadrature-phase signal component Q(kΔt) of the encoded data signal, and delays the quadrature-phase signal component Q(kΔt) by MK₀/2;
a first digital multiplier that multiplies the in-phase signal component I(kΔt) and an output of the first delay module to generate
I(kΔt)*I[(k−MK₀/2)Δt];
a second digital multiplier that multiplies the in-phase signal component Q(kΔt) and an output of the second delay module to generate
Q(kΔt)*Q[(k−MK₀/2)Δt];
an adder-accumulator that receives and accumulates signal 1(kΔt)* I[(k−MK₀/2)Δt], to generate an in-phase autocorrelation coefficient A_{I,d} according to
A_{I,d}=ΣI(kΔt)*I[k−MK₀/2)Δt],
where summation is performed over samples from k=(MK₀/2+1) to k=MK₀;
wherein the adder-accumulator receives and accumulates Q(kΔt)* Q[(k−MK₀/2)Δt] to generate a quadrature-phase autocorrelation coefficient A_{Q,d} according to
A_{Q,d}=ΣQ(kΔt)*Q[(k−MK₀/2)Δt],
where summation is performed over samples from k=(MK₀/2+1) to k=MK₀;
wherein the adder-accumulator combines A_{I,d} and A_{Q,d} to generate a combined signal A_{d} that includes a decoded data symbol, where
A_{d}=A_{I,d}+A_{Q,d}; and
a decision module that determines a sign for the decoded data symbol.

16. The digital receiver of claim 15, wherein the encoded data signal comprises FM0 encoded data, wherein M is equal to 1, wherein the decision module determines a binary data symbol to be corresponding to the sign of combined signal A_{d}, wherein the data symbol equals 0 if the sign is negative, and the data symbol equals 1 if the sign is positive.

17. The digital receiver of claim 15, wherein the encoded data signal comprises Miller encoded data, wherein M is equal to 2, 4, or 8, wherein the decision module determines a binary data symbol to be corresponding to opposite to the sign of combined signal A_{d}, wherein the data symbol equals 1 if the sign is negative, and the data symbol equals 0 if the sign is positive.

18. The digital receiver of claim 15, wherein the encoded data signal comprises data from a backscattered signal received from a radio frequency identification (RFID) tag.

19. The digital receiver of claim 18, wherein the receiver is included in a radio frequency identification (RFID) reader interrogator device.
